(19) United States
(12) Patent Application Publication
(10) Pub. No.: US 2015/0214660 A1
(43) Pub. Date: Jul. 30, 2015

(54) METHOD AND SYSTEM FOR SECURING A CONDUCTIVE BAND INSIDE AN ELECTRICAL CONTACT

(71) Applicant: Electrical Equipment Corporation, Chicago, IL (US)

(72) Inventor: Graeme Sandwith, Chicago, IL (US)

(73) Assignee: Electrical Equipment Corporation, Chicago, IL (US)

(21) Appl. No.: 14/162,943

(22) Filed: Jan. 24, 2014

(51) Int. Cl. H01R 13/631

(52) U.S. Cl. CPC H01R 13/631

(57) ABSTRACT

An electrical contact or electrical contact system includes a connector and a conductive band, the band configured to be disposed within a groove in the connector. The groove may include an undercut configured to receive and secure a portion of the band. The band may be ladder-like in structure, with a plurality of rung-like elements separating a pair of rails, and the portion of the band that may be received by the groove preferably corresponds to no more than at least a part of one rail. The system also may include a retention element, such as a snap ring, which may be configured to fill in the portion of the groove not occupied by the band, thereby holding the band in place and preventing it from becoming dislodged.

### BACKGROUND

1. Field of the Invention

This invention relates to electrical connectors and to securing a conductive band within an electrical contact.

2. Background of the Invention

Electrical connectors are used to transfer power or electrical signals from one source to another. In most situations, a secure, snug fit between connectors is necessary in order to provide a stable connection and optimal electrical transfer.

In order to facilitate this connection, some connectors employ one or more conductive bands that serve one or more purposes. For example, conductive bands may increase a contact surface area between connectors, thereby providing a better conductive path between the elements. In addition, the bands may decrease and/or fill the gap between the outer dimension of a male connector and the inner dimension of a female connection, thereby promoting an interference fit and, again, providing for a better conductive patch.

One of the hallmarks of conductive bands is that they are compressible elements, separable from the connectors in/on which they are installed. Since they are separate elements, they sometimes become dislodged, e.g., during transport, from their seated positions relative to their connectors. In that case, a user may not notice that the band is missing, askew, or not otherwise properly aligned, which may result in an improper fit and poor-to-no connection if the user attempts to couple the faulty connector to another connector.

Alternatively, the user may notice that the band is not properly configured, fixing it prior to coupling the connector to another connector. While this may alleviate the problems discussed above, it may require that the user expend additional time and effort first to verify that each conductive band is seated properly in its respective connector and then to fix any band in need of reorientation.

What is needed is an electrical contact that overcomes one or more of the drawbacks described above.

### SUMMARY OF THE INVENTION

In one aspect, an electrical contact may include a distal end configured to receive a cable, and a proximal end having an opening into a channel, the channel configured to receive another electrical contact. The channel may be substantially cylindrical and may include a groove set back from the opening, and the groove may include an undercut configured to receive a portion of a conductive band and a tab configured to restrict movement of the conductive band portion. The groove also may be configured to receive a retention element such as a snap ring.

The conductive band may have a pair of rails separating a plurality of rungs. The undercut may have an axial depth less than or equal to a width of one of the rails, and the undercut also may have a radial thickness larger than a radial thickness of the tab. Additionally or alternatively, the groove may have an axial width substantially equal to a combined width of the conductive band and the retention element.

In another aspect, an electrical contact system may include an electrical contact, a conductive band, and a retention element. The electrical contact may include a distal end configured to receive a cable, and a proximal end having an opening into a channel, the channel configured to receive another electrical contact. The channel may be substantially cylindrical and may include a groove set back from the opening, and the groove may include an undercut configured to receive a portion of a conductive band and a tab configured to restrict movement of the conductive band portion. The groove also may be configured to receive a retention element such as a snap ring.

Similar to the first aspect, the conductive band may have a pair of rails separating a plurality of rungs. The undercut may have an axial depth less than or equal to a width of one of the rails, and the undercut also may have a radial thickness larger than a radial thickness of the tab. Additionally or alternatively, the groove may have an axial width substantially equal to a combined width of the conductive band and the retention element.

The snap ring may have a thickness defined as a difference between an inner radius and an outer radius, and the groove may have a depth greater than or equal to the snap ring thickness. In addition, the conductive band and the retention element may be configured to press fit into the groove.

These and other features and advantages are evident from the following description of the present invention, with reference to the accompanying drawings.

### BRIEF DESCRIPTION OF THE DRAWINGS

FIG. 1 is a side, partial section view of a female electrical contact.

FIG. 2 is a front view of the contact of FIG. 1.

FIG. 3 is a perspective view of a conductive band configured to interface with an interior channel of the contact of FIG. 1, the band in an uncompressed configuration.

FIG. 4 is a perspective view of the conductive band of FIG. 3 in a compressed configuration.

FIG. 5 is a detailed section view of the proximal end of the contact of FIG. 1.

FIG. 6 is a side view of a retention element used to keep the conductive band of FIG. 3 in place.

FIG. 7 is a side, section view of the contact of FIG. 1, with the conductive band and retention element installed.

FIG. 8 is perspective, section view of the assembly of FIG. 7

FIG. 9 is an exploded view of an electrical contact system, including a section view of the female contact of FIG. 1, the conductive band of FIG. 3, and the retention element of FIG. 6

### DETAILED DESCRIPTION OF THE INVENTION

The electrical contact detailed herein overcomes the drawbacks described above and other drawbacks of conventional contacts by providing means for securing a conductive band in a correct, operable orientation within the contact, even when the contact is not engaged with a second contact.

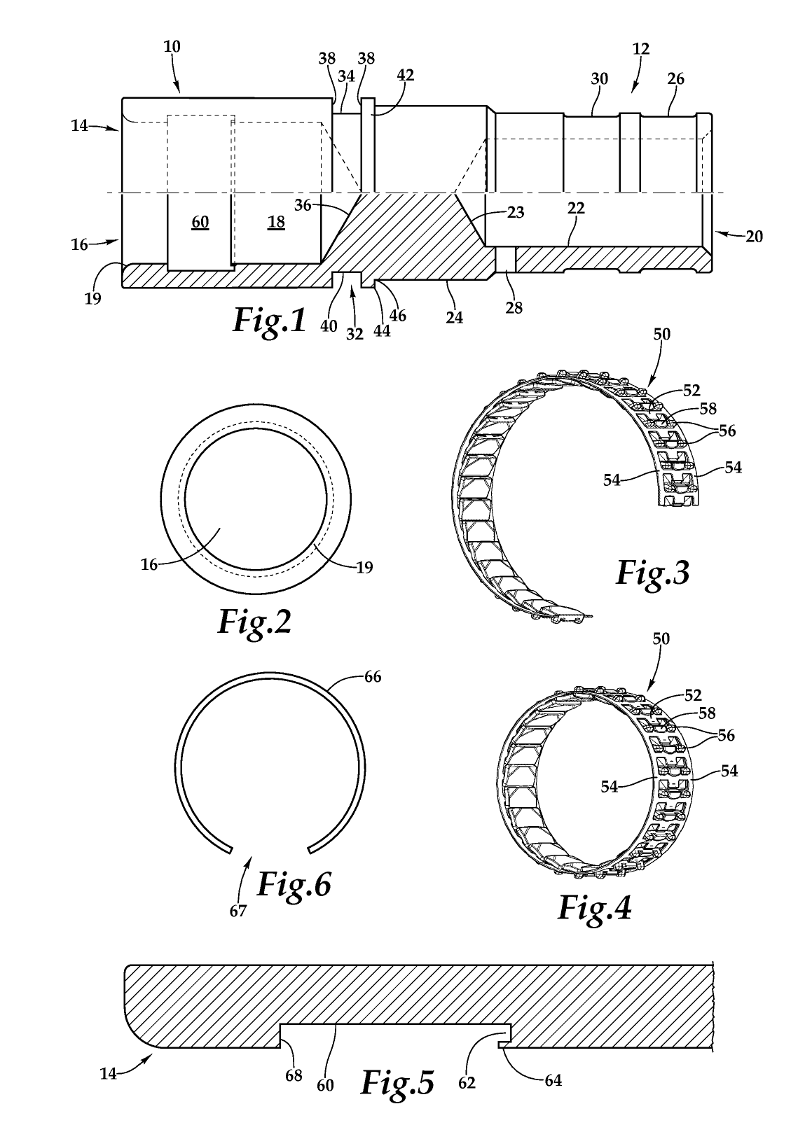

As seen in FIG. 1, contact 10 may include a distal, cable end 12 configured to receive an electrical cable, and a proximal, contact end 14 opposite distal end 12. Proximal end 14 may be configured to interface with another contact (not shown).

Contact 10 preferably is a female contact, such that proximal end 14 includes an opening 16 leading into a channel 18 configured to receive a male contact. Opening 16 also may include a radius of curvature 19 to assist in guiding male contact into opening 16. In one embodiment, radius may be between about 1/16″ and about ⅛″, although other dimensions are possible, depending on the size of contact 10.

Opening 16 preferably is substantially circular, as seen in FIG. 2. Channel 18 preferably is substantially cylindrical, although channel 18 may have variations in its radial depth, as discussed in greater detail below. Similarly, male contact may have a substantially cylindrical proximal end configured to interface with channel 18. Contacts preferably are configured to have an interference fit with one another so as to transmit electricity and so as to avoid accidental disconnection between contacts, which may be important because contacts may carry large loads.

In another embodiment, opening 16 and/or channel 18 may not be substantially circular or cylindrical, respectively, but instead may be shaped so as to receive and interface with the male contact. For example, the opening may be rectangular, hexagonal, octagonal, etc., such that the male contact may be received within opening 16 in a finite multiple number of orientations.

Alternatively, the opening and/or channel may be configured uniquely, such that the male contact may be received within opening 16 in only one possible orientation. This configuration may result from a shape of opening 16 and/or channel 18 or it may result from additional structure within opening 18 that provides for only one possible orientation, such as a rib or tab on one of the contacts with a matching groove on the other contact.

In one embodiment, contact 12 may be a busbar-type contact, such that distal end 12 may be configured to be located in a substantially unchanging, fixed location, such as operatively coupled to and protruding from a panel mounted to a bulkhead or extending through a wall. In this type of contact, distal end 14 may include a plurality of openings, such that contact is configured to receive a plurality of fasteners in order to retain a busbar in electrical contact with distal end 14.

In another embodiment, as shown in more detail in the figures, contact 10 may be a crimp-style contact, having a contact end 14 and a cable end 12. In this style of contact, distal end 12 also may include an opening 20 and channel 22 configured to receive a cable (not shown).

Cables for use with system may come in various gauges, e.g., 4/0 AWG, 313 MCM, 444 MCM, 535 MCM, 646 MCM, or 777 MCM. Preferably, each style of cable contact remains substantially the same at contact end, regardless of the size of cable used. Busbar-type male contact also may remain substantially the same at distal end 14, regardless of cable size, since it is configured to couple to a busbar and not directly to a cable. Conversely, however, a crimp-style contact may be customized at distal end 14 in order to receive cable of a predetermined size. Specifically, clearance may vary depending upon cable size. For example, a larger cable such as a 777 MCM cable may experience an interference fit, causing insulation to stretch, wherein a 4/0 cable may see a radial gap of up to about ¼″ between cable and opening inner wall 22. The cable may be crimped or soldered into crimp bucket, i.e., against inner wall 22. In addition, a thickness of wall surrounding opening in cable end 14 may vary slightly depending upon the cable size with which contact 10 is configured to be used, although, in one embodiment, wall thickness may be between about ¼″ and about ⅜″, including tolerance variations of +/− about 1/64″.

Exterior surface 24, particularly exterior surface 26 proximate distal end 12 may be configured to assist in securing cable within channel 22. For example, there may be an opening 28 through exterior surface 26, the opening configured to receive a fastener. Alternatively, and preferably, opening 28 may be a witness hole, which may be used to verify that the cable is disposed a sufficient depth into channel 22, e.g., prior to being crimped inside channel 22. Opening may be spaced anywhere along a length of distal end 12 overlying channel 22, although it is shown proximate an innermost end 23 of channel in FIG. 1.

Additionally or alternatively, exterior surface 26 may include one or more grooves 30. Grooves 30 may be configured to receive crimping jaws (not shown), which may be engaged after cable is inserted into channel 22, thereby decreasing the dimensions of channel 22 and causing channel 22 to compress against cable.

Distal end exterior surface 26 and/or grooves 30 may have substantially circular cross-sections, although their shape may be immaterial, as distal end may be compressed or otherwise deformed by crimping.

Exterior surface 24 also may be surrounded by insulation (not shown), which may be rubber or some other nonconductive material. Exterior surface of contact 10 may be generally a mirror image of interior surface of insulation.

Interior surface of insulation may be sized so as to form a compression fit with contact, thereby keeping insulation in place and preventing it from sliding relative to contact 10. In addition, exterior surface 24 may contain retention features 32 further configured to prevent insulation from moving relative to contact 10.

In one embodiment, retention feature 32 may include a groove 34 configured to interface with a protrusion extending inward from insulation interior surface. Groove 34 may be disposed laterally along contact 10 proximate an innermost end 36 of channel 18 and may have a plurality of sidewalls 38 bounding a base surface 40. Sidewalls 38 may extend radially inwardly to a depth generally equal to, and preferably slightly outward of walls of channel 18. For example, in one embodiment, channel 18 may have a radius of about ½ inch, while base surface 40 may spaced about ⅝ inches away from central axis of contact 10, as seen in FIG. 1.

Sidewalls 38 preferably include sharp corners at exterior surface 24, e.g., of about 90 degrees, in order to keep insulation protrusion retained within groove 34. In a second embodiment, sidewalls may include a slight radius of curvature, e.g., about 1/100 inch. In still another, less preferred, embodiment, sidewalls 38 and exterior surface 24 may form an acute angle, which may form an undercut configured to receive and lock insulation into place.

Retention feature 32 also may include one or more shoulders 42 configured to interface with a matching shoulder on insulation. Shoulder 42 may be disposed proximate groove 34 and may include a sidewall 44 extending inward to a radial depth less than a depth of groove 34. For example, a base 46 of shoulder 42 may be spaced about 11/16″ from central axis, yielding a shoulder height of about 1/16″.

Contact 10 may be configured to receive a conductive band 50, which may facilitate an electrical connection between contacts, e.g., by forming a smaller opening within channel with additional surface area for the male contact to contact. Conductive band may be shaped to interface with the inner surface of channel 18 against which it abuts. For example, when channel 18 is cylindrical, band 50 also may be cylindrical.

Turning to FIGS. 3-4, band 50 may be relatively heavy, yet flexible, given its size and thickness. Band 50 also may be a torsion spring or leaf spring, applying an expansive, resistive force when compressed. As such, band 50 may expand outward to press against channel 18 sidewalls after being inserted into channel.

One such class of conductive band 50 may be multilam bands manufactured by Multi-Contact AG, although other types of conductive bands may be used.

As seen in FIGS. 3-4, conductive band 50 may comprise a steel ladder 52 comprising a pair of side rails 54 with a plurality of rungs 56 disposed therebetween. A rung 56 may be twisted or straight and further may include a heavy conductive pad 58, which may facilitate electrical conduction. Band 50 also may be substantially symmetrical, such that it may not matter which rung is inserted first into channel 18.

In one example, band 50 may have a width between about ¼″ and about ¾″. Each rung 56 may have a width between about 3/16″ and about ⅝″ and a thickness between about 0.004″ and 0.02″. In a specific embodiment, band 50 may be about 0.47″ wide, with stepped rung widths between about 0.04″ and 0.1″, and a thickness of 0.006″. In that embodiment, pads 58 may be about 0.335″×0.129″×0.48″.

Turning now to FIG. 5, which shows a detailed section view of proximal end 14 of contact 10, channel 18 may include a groove 60 configured to receive band 50. Groove 60 may have a depth that is deep enough to hold band 50 while remaining shallow enough so that conductive pads 58 on band 50 extend radially inward from channel 18, thereby ensuring that pads 58 make electrical connection with the mating male contact. In one embodiment, groove 60 may be between about 1/32″ and about 1/16″ deep.

Groove 60 may be located anywhere along channel 18. In one embodiment, proximal end 68 of groove 60 is set back from entrance 16. For example, proximal end 68 of groove 60 may be located at between about ⅕ and about ⅙ of a depth of channel 18. In another example, proximal end 68 of groove 60 may be located about ⅓″ from entrance 16.

In order to retain band 50 within groove 60, groove 60 may feature an undercut 62 disposed axially distally from a remainder of groove 60. Undercut 62 may be formed by removing a portion of contact underneath a tab 64 of inner channel 18, thereby leaving tab 64 extending proximally from an end of groove 60.

Undercut 62 and, therefore, tab 64 preferably has an axial depth smaller than a width of rail 54 on band 50, so that rungs 56 do not abut tab 64. For example, undercut and tab may be between about 1/64″ and about 1/32″ deep, and in one embodiment they may be about 0.026″ deep.

Undercut 62 may have a radial depth greater than or equal to a thickness of rail 54 of band 50. Preferably, radial depth of undercut may be generally equal to rail thickness, thereby providing a secure fit between band 50 and contact 10.

In order to keep band 50 in place and not sliding axially after installation, system 100 also may include a retention element 66, such as the element seen in FIG. 6. Retention element may have a shape configured to interface with both band 50 and groove 60. Preferably band 50 and groove 60 have substantially the same cross-section, thereby maximizing surface contact area and electrical conductivity between them. Thus, when both band and groove have generally circular cross-sections, retention element 66 also may be generally circular and may be referred to as a retention ring or a snap ring.

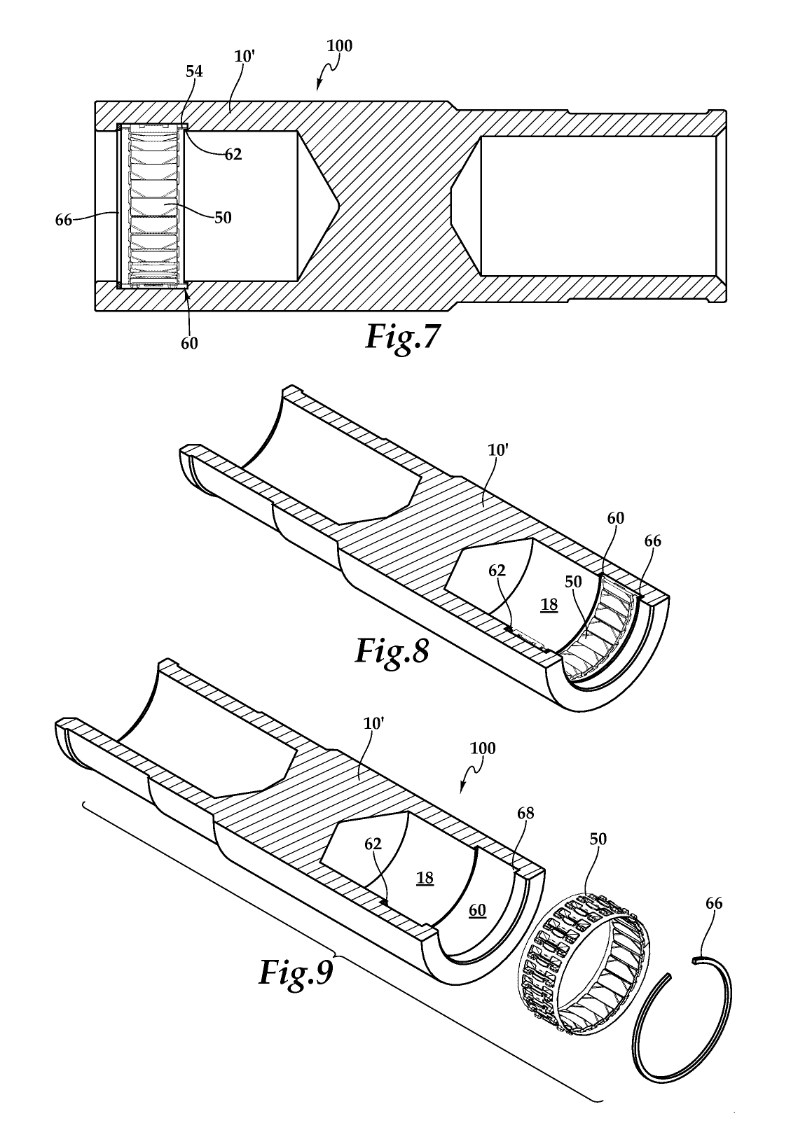

In order to keep band 50 in place, band 50 and retention ring 66 preferably have a combined axial width configured to cause retention ring 66 to be press fit into groove, i.e., axial width of retention ring 66 may be substantially equal to the width of the axial gap formed on the proximal side of band 50, after band 50 is seated in groove 60, with at least a portion of the rail 54 seated in undercut 62, as seen in FIG. 7. (The contact in this embodiment is denoted as 10′ to indicate that it includes a few structural features different that the embodiment of FIG. 1. The majority of the features of contact 10′ are identical to those of contact 10, such that they have the same reference numeral designations in both embodiments.)

In one embodiment in which a rail 54 completely spans axial length of undercut 62, this may mean that the combined width may be substantially equal to axial width of groove 60, including undercut 62, as seen in FIG. 8.

In another embodiment in which undercut 62 is wider than rail 54, such that rungs 56 abut tab 64, this may mean that the combined width of the retention ring 66 and the band 50, minus one rail, may be substantially equal to a width of groove 60, excluding undercut 62.

Retention ring 66 may be configured to move through channel 18 and then expand to fit securely within groove. As such, ring 66 may comprise a ring segment with a circumferential extent between about 280 degrees and about 330 degrees, and in one embodiment, about 305 degrees. The break in the body of ring 66 may narrow when compressed so as to fit ring within channel 18. Once groove 60 is reached, body of ring 66 may expand, thereby opening gap 67.

Ring 66 may include an outer perimeter having substantially the same dimensions as proximal portion 68 of groove 60. In addition, ring 66 may include an inner perimeter sized slightly larger than a dimension of channel 18, such that ring 66 may sit flush with or may be slightly receded relative to channel 18, so as to not interfere with engagement between channel 18 and a male contact.

With reference to the exploded view of FIG. 9, to assemble system 100 (before or after cable is secured to contact 10′), conductive band 50 may be inserted through opening 16 into channel 18 at distal end 12 of contact 10 until it reaches groove 60. At that point, band 50 may expand to seat within groove. Band 50 then may be inserted further into channel until at least a portion of one rail 54 of band 50 is disposed within undercut 62 and until band 50 cannot be slid further within groove 60. Retention element 66 then may be inserted through opening 16 into channel 18 until it reaches groove 60. Retention element 66 then may be inserted into groove, expanding upon insertion. Once disposed fully within groove 60, retention element 66 coupled with a portion of band 50 being held in undercut 62 may cause band 50 to be held in place securely and to resist becoming dislodged and/or disoriented.

While the foregoing written description of the invention enables one of ordinary skill to make and use what is considered presently to be the best mode thereof, those of ordinary skill will understand and appreciate the existence of variations, combinations, and equivalents of the specific exemplary embodiment and method herein. The invention should therefore not be limited by the above described embodiment and method, but by all embodiments and methods within the scope and spirit of the invention as claimed.

We claim:

1. An electrical contact, comprising:
a distal end configured to receive a cable; and
a proximal end having an opening into a channel, the channel configured to receive another electrical contact;
the channel including a groove set back from the opening,
the groove including an undercut configured to receive a portion of a conductive band and a tab configured to restrict movement of the conductive band portion.

2. The electrical contact of claim 1, wherein the channel is substantially cylindrical.

3. The electrical contact of claim 1, wherein the groove also is configured to receive a retention element.

4. The electrical contact of claim 3, wherein the retention element is a snap ring.

5. The electrical contact of claim 1, wherein the conductive band comprises a pair of rails separating a plurality of rungs, and wherein the undercut has an axial depth less than or equal to a width of one of the rails.

6. The electrical contact of claim 1, wherein the groove also is configured to receive a retention element, and further wherein the groove has an axial width substantially equal to a combined width of the conductive band and the retention element.

7. The electrical contact of claim 1, wherein the undercut has a radial thickness larger than a radial thickness of the tab.

8. An electrical contact system, comprising:
an electrical contact, a conductive band, and a retention element;
the electrical contact having:
a distal end configured to receive a cable;
a proximal end having an opening into a channel, the channel configured to receive another electrical contact;
the channel including a groove set back from the opening,
the groove including an undercut configured to receive a portion of the conductive band and a tab configured to restrict movement of the conductive band portion.

9. The electrical contact system of claim 8, wherein the retention element is a snap ring.

10. The electrical contact system of claim 8, wherein the conductive band comprises a pair of rails separating a plurality of rungs, and wherein the undercut has an axial depth less than or equal to a width of one of the rails.

11. The electrical contact system of claim 8, wherein the groove has an axial width substantially equal to a combined width of the conductive band and the retention element.

12. The electrical contact system of claim 8, wherein the undercut has a radial thickness larger than a radial thickness of the tab.

13. The electrical contact system of claim 8, wherein the retention element is a snap ring having a thickness defined as a difference between an inner radius and an outer radius, and wherein the groove has a depth greater than or equal to the snap ring thickness.

14. The electrical contact system of claim 8, wherein the conductive band and the retention element are configured to press fit into the groove.
